(19) United States
(12) Patent Application Publication
(10) Pub. No.: US 2026/0185769 A1
(43) Pub. Date: Jul. 2, 2026

(54) INNER LINER FOR REFRIGERATOR

(71) Applicant: ELECTROLUX APPLIANCES AKTIEBOLAG, Stockholm (SE)

(72) Inventors: Corrado CECCHINI, Porcia (IT); Alfredo BASSAN, Porcia (IT); Gilda DE LUCA, Porcia (IT); Chiara BARACCHINI, Porcia (IT); Simone PAVAN, Porcia (IT); Silvia DOTTOR, Porcia (IT)

(21) Appl. No.: 19/131,371

(22) PCT Filed: Nov. 28, 2022
(86) PCT No.: PCT/EP2022/083425

§ 371 Date: May 20, 2025

(51) Int. Cl. F25D 23/06; B29C 48/21; B29K 25/00; B29K 105/26; B29L 9/00; B29L 31/00; B32B 27/30; B32B 37/15

(52) U.S. Cl. CPC F25D 23/066; B29C 48/21; B32B 27/302; B32B 37/153; B29K 2025/06; B29K 2105/26; B29K 2995/0097; B29L 2009/00; B29L 2031/7622; B32B 2250/03; B32B 2305/70; B32B 2307/7376; B32B 2325/00

(57) ABSTRACT

Described is a refrigerator inner liner (40) is provided. The refrigerator inner liner comprises a first layer (41) of a recycled material adapted to face the insulation wall of a refrigerator and a second layer (42) of virgin material adapted to face the inside of a cooled refrigerator compartment. Hereby less virgin material is needed to be used when producing the inner liner whereby and less, new, virgin material is required.

### TECHNICAL FIELD

The present disclosure relates to a refrigerator and to a refrigerator inner liner and also to a method for producing a refrigerator inner liner.

### BACKGROUND

Refrigerators are used to keep goods such as food, beverage and the like at a cooled temperature in a cooled compartment. If the refrigerator is used to keep the goods at a temperature below the freezing point the refrigerator is sometimes called a freezer. However, the term refrigerator will be used for any apparatus used to store goods at a cooled temperature such that the temperature inside the refrigerator can be lower than the ambient air outside the refrigerator.

In a refrigerator, the goods to be kept cooled is placed in a cooled compartment. The cooled compartment is delimited by walls and typically also a door of some sort to access the cooled compartment. The inside of the walls of the cooled compartment and typically also the door for accessing the cooled compartment is covered by an inner liner. The inner liner for refrigerators is typically produced by vacuum forming sheets or coils/rolls of some suitable material such as High Impact Polystyrene (HIPS) or Acrylonitrile butadiene styrene (ABS). The sheets and rolls typically comprise a main layer and a cap layer. The cap layer is provided to get a proper surface finishing of the liner. For example, US2012187132 describes known structures for a liner inside the cooled refrigerator compartment. Also, WO2015/096968 and WO2017/088913 set out different methods of how an inner liner for a refrigerator can be manufactured.

Further, all interior parts of refrigerators, and therefore also inner and door liners, are subject to food contact certification. Such certification can be obtained through migration tests according to an official protocol. For example, food simulants are in contact with a part of a surface and through chemical analysis the presence of potential contaminants is checked. The supplier of raw material is required to provide a certificated list of potential contaminants based on their own production process.

There is a constant desire to improve the refrigerators and to reduce the cost for manufacturing refrigerator. Hence, there exists a need for an improved refrigerator.

### SUMMARY

It is an object of the present invention to provide a more sustainable refrigerator and refrigerator liner and also a method of producing a refrigerator liner.

This object and/or others are obtained by the refrigerator liner, method and refrigerator as set out in the appended claims. In particular, the amount of virgin material is reduced because replaced with recycled (post-consumer) one, providing a reduction of CO2 emissions on life cycle of the finished product.

As has been realized by the inventors, due to the requirement of food contact contamination, re-cycled materials cannot be used in the inner liner because the food contact contamination requirement would then not be met. However, to use recycled material in refrigerators would be desirable both from a production cost point of view and also to make the finished product more environmentally friendly.

The inventors have discovered that recycled material can be used in the inner liner and still meet the requirement of food contact contamination. This is obtained by providing a layer of virgin (clean) material in-between the cooled compartment and the re-cycled material of an inner liner. Hereby less virgin material is needed to be used when producing the inner liner whereby and less, new, virgin material is required.

In accordance with the invention a refrigerator inner liner is provided. The refrigerator inner liner comprises a first layer of a re-cycled material adapted to face the insulation wall of a refrigerator and a second layer of virgin material adapted to face the inside of a cooled refrigerator compartment. Hereby less virgin material is needed to be used when producing the inner liner whereby and less, new, virgin material is required.

In accordance with some embodiments the second layer is placed in direct contact with the first layer. Hereby an efficient production of the multi-layer refrigerator inner liner comprising both virgin and re-cycled material can be obtained. For example, the multi-layer refrigerator inner liner can be produced in a co-lamination or a co-extrusion process.

In accordance with some embodiments, a third layer, a cap layer, is placed onto the second layer.

In order to maximize the benefit from the multilayer refrigerator inner liner the refrigerator inner liner the third, cap layer can in some embodiments have a thickness of 0-200 μm. Further, in accordance with some embodiments the second layer can have a thickness of 100-1000 μm. Also, in accordance with some embodiments the first layer can have a thickness of 900-4800 μm.

The invention also extends to a refrigerator comprising an inner liner as set out above and also to a method for producing a refrigerator inner liner. The refrigerator inner liner as described is suitable both for the inside walls of the refrigerator and for the door for accessing the refrigerator.

### BRIEF DESCRIPTION OF THE DRAWINGS

The present invention will now be described in more detail by way of non-limiting examples and with reference to the accompanying drawings, in which:

FIG. 1 is a view of a refrigerator,

FIG. 2 is a partial cross-sectional view of the refrigerator of FIG. 1.

FIG. 3 is a cross-sectional view of a refrigerator inner liner, and

FIGS. 4a and 4b illustrate steps performed when manufacturing a refrigerator inner liner.

### DETAILED DESCRIPTION

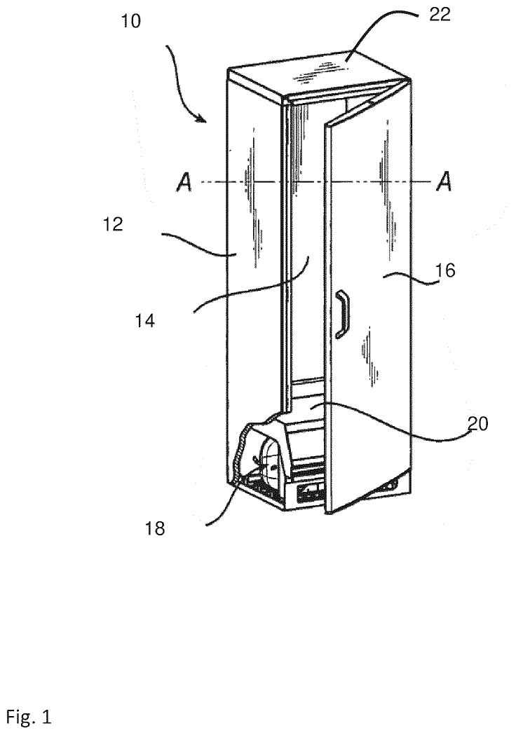

In FIG. 1 a refrigerator 10 is depicted. The refrigerator 10 can be any type of appliance designed to keep goods at a cooled temperature and can typically be a household refrigerator or a household freezer. The goods stored in the refrigerator can typically be food. The term refrigerator is used herein to refer to any apparatus used for keeping goods at a temperature cooler than the ambient air. The refrigerator 10 is delimited by walls 12. The refrigerator 10 has a cooled compartment 14. The cooled compartment 14 can be accessed via a door 16. The door 16 can be any type of opening used for accessing the cooled compartment such as a drawer or so-called French doors. The cooled compartment 14 is delimited by the walls 12, a top section 22 and a bottom section 20. The cooled compartment 14 is cooled by a cooling arrangement 18 in a conventional manner.

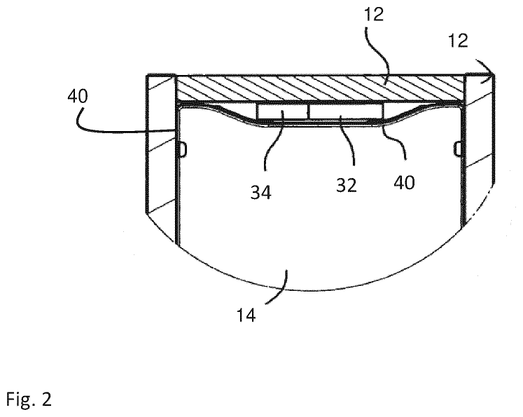

In FIG. 2, a partial cross-sectional view from above along the line A-A of FIG. 1 is shown. In FIG. 2 an inner liner 40 is shown located inside the refrigerator. The liner 40 is located on the inside walls of the cooled compartment 14. The inner liner can also be provided on the inside of the door 16 and also the top section 22 and the bottom section 20 such that all of the inside of the cooled compartment is covered by the inner liner 40. Further, behind the liner 40 additional components such a controller 32 and a duct 34 can be located.

It is to be noted that the exemplary configuration of the refrigerator in the example of FIGS. 1 and 2 only illustrates one of many possible configurations. For example, multiple cooled compartments can be provided. The cooled compartments can in some embodiments comprise one or multiple freezer compartments.

Conventional inner and door liners of refrigerators are typically produced by vacuum forming sheets or coils made of styrene-based virgin plastics or similar materials.

Normally, the sheets and coils consist of two-layers: a thick bulk layer that provides the structural and mechanical strength to the liner, and a thin co-extruded cosmetic layer (cap layer) that provides a higher gloss to its visible surface. No post-consumer recycled polystyrene is used.

In accordance with the invention a refrigerator inner liner is provided that comprises re-cycled material.

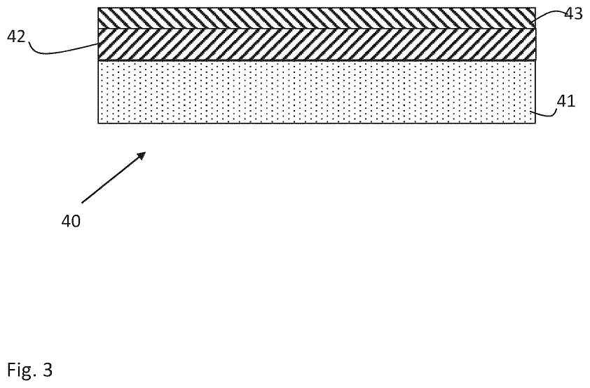

In FIG. 3, the structure of an exemplary refrigerator inner liner 40 is shown in more detail in a cross-sectional view. The refrigerator inner liner comprises a first layer 41 of a re-cycled material and a second layer 42 formed by a virgin (i.e., non-recycled) material is provided. Additional layers can also be provided. For example, a glossy, so-called cap-layer 43 can also be provided.

The second, virgin layer 42 is provided to prevent food contact contamination from the first layer formed by a re-cycled material. It can be advantageous to use HIPS for both the first layer 41 of re-cycled material and for the second layer 42 of virgin material. In such an embodiment the thickness of the different layers can be (for extruded sheets and coils):
cap layer 43 can advantageously have a thickness 0-200 μm; this layer is usually not present when the surface finishing is matt.
virgin layer 42 can advantageously have a thickness of 100-1000 μm, and
re-cycled layer 41 can advantageously have a thickness of 900-4800 μm.

By selecting the thickness of the materials in the above manner, it is possible to use a large amount of re-cycled material and at the same time meet the requirements relating to food contamination.

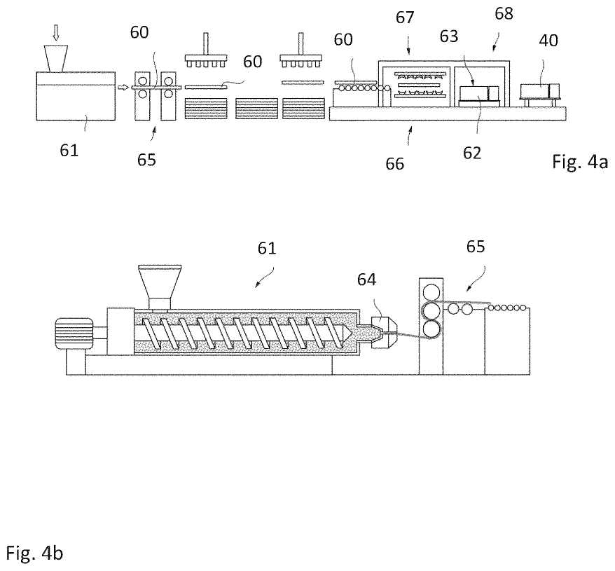

In FIGS. 4a-4b some method steps of a production process of a refrigerator inner liner (and a refrigerator door liner) is depicted.

The manufacturing method of the invention basically comprises first extruding the material into sheets 60, by using an extruder 61. Then a sheet 60 is transformed by means of a male mold 62 having a shaping surface 63 to shape a refrigerator liner 40.

As shown in FIG. 4b, the extruder 61 can preferably have a plane dye 64 to produce a thin, flat planar flow.

Since the extruding process can generate, inside the material, internal stresses that can then be released at high temperature, during the following thermoforming process, it is advantageous to control the extruding process in order to obtain a nearly unoriented sheet.

The extruded material which exits from the dye 64 is pulled through a rolling unit 65, comprising a set of cooling rolls, where the material is cut into sheets 60, the sheets 60 are cooled and the final thickness of each sheet 60 is determined precisely. The sheets 60 are then stacked.

Each individual sheet 60 is then supplied to a thermoforming section 66, comprising a heating unit 67 and a forming unit 68.

In the thermoforming section 66, the sheet 60 is first heated, for example by passing through the heating unit 67; and then shaped by thermoforming in the forming unit 68 to form the liner 40.

In order to form a two-or three-layer refrigerator inner liner 40, the sheets 60 can for example be produced through a co-extrusion or through a co-lamination process or some other suitable process.

When a co-extrusion process is used, a second (and third) layer of melt polymer is poured onto the main layer through a second extruder (third extruder) not shown. Then, both layers can then be forced to pass through a set of common rolls between die, 64, and rolling unit, 65. After cooling, the two (or more) layers are cohesively stuck.

When a co-lamination process is used, a second (and third) layer is extruded separately and then it is heated-up to melting before passing through a set of rolls.

A similar process can be applied in order to extrude coils for the vacuum forming of door liners.

The refrigerator inner liner as described herein, it is made possible to use a certain amount of recycled material such as polystyrene, coming from post-consumer sources when producing the refrigerator inner liner. Thus, while recycled polystyrene or similar materials cannot be used in direct contact with food, the provision of an additional layer, free of recycled material is added to act as a barrier against the migration of possible contaminants from the recycled material to the food. Hereby the use of clean (virgin) material can be significantly reduced and re-cycled material can be used instead. This will typically reduce the manufacture cost of refrigerators and also the environmental impact by lowering the carbon footprint.

1. A refrigerator inner liner (40) comprising first layer (41) of a re-cycled material adapted to face the insulation wall of a cooled refrigerator compartment and a second layer (42) of virgin material adapted to face the inside of a cooled refrigerator compartment.

2. The refrigerator inner liner (40) according to claim 1, wherein the second layer is placed in direct contact with the first layer.

3. The refrigerator inner liner (40) according to claim 2, where a third, cap layer (43) is placed onto the second layer.

4. The refrigerator inner liner (40) according to claim 1, wherein the cap layer has a thickness of 0-200 μm.

5. The refrigerator inner liner (40) according to claim 1, wherein the second layer has a thickness of 100-1000 μm.

6. The refrigerator inner liner (40) according to claim 1, wherein the first layer has a thickness of 900-4800 μm.

7. A refrigerator (10) comprising a cooled compartment (14) and a door (16) for accessing the cooled compartment, wherein the inside walls (12) of the cooled compartment are provided with the refrigerator inner liner (40) according to claim 1.

8. The refrigerator (10) according to claim 7, wherein the door (16) is provided with the refrigerator inner liner (40) according to claim 1.

9. A method of producing a refrigerator inner liner (40) comprising to provide a first layer (41) of a re-cycled material adapted to face the insulation wall (12) of a refrigerator (10) and a second layer (42) of a virgin material adapted to face the inside of a cooled refrigerator compartment (14), wherein the second layer (42) is placed in direct contact with the first layer (41).

10. The method according to claim 9 further comprising to provide a cap layer (43) placed onto the second layer.

11. The method according to claim 9, wherein a co-extrusion process is used to place the second layer onto the first layer.

12. The method according to claim 9, wherein a co-lamination process is used to place the second layer onto the first layer.

13. The method according to claim 9, wherein a co-extrusion process is used to place the cap layer onto the second layer.

14. The method according to claim 9, wherein a co-lamination process is used to place the cap layer onto the second layer.
